(19) United States
(12) Patent Application Publication
(10) Pub. No.: US 2024/0369074 A1
(43) Pub. Date: Nov. 7, 2024

(54) FAN CONNECTING STRUCTURE AND MAGIC LINK FAN

(71) Applicant: MECHANIC (SHANGHAI) TECHNOLOGY CO., LTD., Shanghai (CN)

(72) Inventor: Zhe HU, Changsha (CN)

(73) Assignee: MECHANIC (SHANGHAI) TECHNOLOGY CO., LTD., Shanghai (CN)

(21) Appl. No.: 18/775,782

(22) Filed: Jul. 17, 2024

Related U.S. Application Data
(63) Continuation of application No. PCT/CN2022/123382, filed on Sep. 30, 2022.

(30) Foreign Application Priority Data
Jan. 24, 2022 (CN) 202220193971.2

(51) Int. Cl. F04D 29/64; F04D 25/06

(52) U.S. Cl. CPC F04D 29/644; F04D 25/0693

(57) ABSTRACT

The disclosure relates to the technical field of fans, and discloses a fan connecting structure and a magic link fan. The fan connecting structure includes a connector and first connecting portions arranged on adjacent fans. The connector includes a substrate. The substrate is provided with second connecting portions detachably combined with the first connecting portions. The first connecting portion is provided with first contact points. The substrate is provided with second contact points in contact with the first contact points. The second contact points are electrically connected to a fan circuit board. The fan connecting structure and the magic link fan provided by the disclosure solve the problem of messy wires for series connection of the fans in the prior art, leading to the difficulty in organizing wires in a fan mounting space.

### CROSS-REFERENCE TO RELATED APPLICATIONS

The application claims priority to Chinese patent application No. 202220193971.2, filed on Jan. 24, 2022, the entire contents of which are incorporated herein by reference.

### TECHNICAL FIELD

The disclosure relates to the technical field of fans, and in particular to a fan connecting structure and a magic link fan.

### BACKGROUND

All the existing case fans are individually wired to realize the power supply and RGB light electrical connection control. A case typically uses a plurality of fans, but there are limited fan and RGB light interfaces provided by the computer motherboard, so the fans are usually powered by means of one-in-multiple-out series connection or a concentrator at present. For the RGB interface, a plurality of fans are connected in series in a one-in-two-out manner to one interface, which is connected to the light control on the motherboard. The traditional one-in-multiple-out connection manner needs to connect a plurality of fans together, so there are messy and numerous wires, which leads to a difficulty in organizing wires in the fan mounting space. Moreover, there are numerous connectors, which may easily cause poor contact, affecting the use effect of the product.

### SUMMARY

An objective of the disclosure is to provide a fan connecting structure and a magic link fan, in order to solve at least one of the above problems in the prior art.

In order to achieve the above objective, the disclosure adopts the following technical solutions:

A fan connecting structure includes a connector and first connecting portions arranged on adjacent fans. The connector includes a substrate. The substrate is provided with second connecting portions detachably combined with the first connecting portions. The first connecting portion is provided with first contact points. The substrate is provided with second contact points in contact with the first contact points. The second contact points are electrically connected to a fan circuit board.

In this technical solution, the adjacent fans are provided with the first connecting portions, the connector includes the substrate and the substrate is provided with the second connecting portions detachably combined with the first connecting portions, so the adjacent fans can be connected by means of the detachable combination between the second connecting portions on the substrate and the first connecting portions. Moreover, the first connecting portion is provided with the first contact points, the substrate is provided with the second contact points, the first contact point and the second contact point are in contact and electrically connected with each other, and the second contact points are electrically connected to the fan circuit board. Therefore, according to this design, the plurality of fans 2 can be electrically connected in series without using complicated wires, but only by means of the connector connected between the first connecting portions of the adjacent fans. By means of this design, the plurality of fans can be electrically connected in series without physical wires, which solves the problem of messy and numerous wires in the existing design where the adjacent fans must be powered by multiple wires connected in series or by a concentrator, directly leading to the difficulty in organizing wires in the fan mounting space.

It should be noted that the first connecting portions are detachably combined with the second connecting portions. The detachable combination here includes detachable fixed connection and detachable movable connection. When the detachable fixed connection is selected, after the adjacent fans are connected by the connectors, the positions of the two fans can be relatively fixed without external auxiliary limiting structures, thereby ensuring the contact effect between the first contact points and the second contact points. However, in another case, even when the detachable movable connection has been used between the first connecting portions and the second connecting portions, external auxiliary limiting structures may further be used to fix and limit adjacent fans or a plurality of fans, which can also ensure the contact effect between the first contact point and the second contact point and the series electrical connection between the adjacent fans and can also achieve the design objective of this technical solution. Therefore, the detachable combination between the first connecting portions and the second connecting portions is not limited to the detachable fixed connection therebetween.

Further, in order to effectively limit the relative positions of the adjacent fans such that the adjacent fans can be stably kept electrically connected in series when there is no external auxiliary limiting structure for auxiliary limiting, the first connecting portion includes a first limiting structure and a second limiting structure that restrict the connector from free disengagement, and the second connecting portion includes a third limiting structure fitted with the first limiting structure to realize detachable combination, and a fourth limiting structure fitted with the second limiting structure to realize detachable combination.

It should be noted that although the first limiting structure is fitted with the third limiting structure to realize detachable combination, the second limiting structure is fitted with the fourth limiting structure to realize detachable combination. That is, there are four detachable combination positions between the connector and the two adjacent fans. By means of the design of the four detachable combination positions, the connector can be detachably fixed between the adjacent fans from multiple directions, thereby achieving the effect of detachable fixed connection.

Specifically, the fit between the first limiting structure and the third limiting structure can restrict the connector from free disengagement in a Z direction, and the fit between the second limiting structure and the fourth limiting structure can restrict the connector from free disengagement in an X direction. The X direction and the Z direction are perpendicular to each other.

Further, in order to provide a detachable fixed connection manner between the fans and the connector, the first limiting structure is in a sliding fit with the third limiting structure, and the second limiting structure is in a snap fit with the fourth limiting structure.

Specifically, the first limiting structure may be a sliding slot arranged on the fan, and the third limiting structure may be a sliding portion that is in a sliding fit with the sliding slot. The second limiting structure may be a snap fit slot arranged on the fan, and the fourth limiting structure may be a snap fit fastener arranged on the substrate.

Of course, in the case where the connection relationship between the sliding slot and the sliding portion and the connection relationship between the snap fit slot and the snap fit fastener are kept unchanged, they may be arranged either on the fan or the connector.

For example, the sliding slot may also be arranged on the connector, the sliding portion may also be arranged on the fan, the snap fit fastener may also be arranged on the fan, and the snap fit slot may also be arranged on the connector.

Further, in order to better realize the side-by-side arrangement between the adjacent fans, the first limiting structure and the third limiting structure slide in an X direction, and the X direction is perpendicular to a rotation axis L of the fan.

Further, in order to realize arbitrary adjustment of the distance between the adjacent fans according to needs, the snap fit position between the second limiting structure and the fourth limiting structure is arbitrarily adjustable.

Further, in order to design a connection manner in which the distance between the adjacent fans is fixed, a snap fit position between the second limiting structure and the fourth limiting structure is a fixed snap fit position, and the fixed snap fit position is at a termination end of the sliding fit between the first limiting structure and the third limiting structure.

Specifically, according to the above design, the fixed snap fit position is at the termination end of the sliding fit between the first limiting structure and the third limiting structure. That is, only when the first limiting structure slides to the extreme position of the sliding fit relative to the third limiting structure, the second limiting structure is in a snap fit with the fourth limiting structure, and the distance between the adjacent fans can be fixed.

It should be noted that in the actual application process, if the adjacent fans need to be arranged side by side in close proximity to each other, then the length of the connector is equal to the distance between the two fixed snap fit positions when the two adjacent fans are side by side in close proximity to each other.

If the adjacent fans need to arranged side by side at a fixed distance, then the length of the connector is greater than the distance between the two fixed snap fit positions when the two adjacent fans are side by side in close proximity to each other.

Further, the fan is provided with contact heads, and the first contact point is located at a top of the contact head. The contact head is a spring ejector pin. With the spring ejector pin, the position of the first contact point can retract when the first contact point is pressed by the second contact point. In this way, when the connector is connected with the fans, the first contact point and the second contact point can be kept in close contact with each other, thereby achieving the electrical connection effect and preventing poor contact from affecting the use effect of the product.

It should be noted that the first contact points are arranged in one-to-one correspondence to the second contact points, and the number of the first contact points and the number of the second contact point may be adaptively increased or decreased according to the needs for functional expansion of the fans.

For example, in an RGB fan, a motor electrical connection interface and an RGB light interface are needed. Therefore, when this design is applied to an RGB fan, the numbers of the first contact points and the second contact points are respectively six. The numbers of the first contact points and the second contact points for controlling the motor and the RGB light are respectively three.

Further, in order to facilitate the effective contact between the second contact point and the first contact point, the connector is provided with a contact surface, the contact surface is provided with conductive sheets, and the second contact points are located on the conductive sheets.

With the conductive sheets, the position of the second contact point is not limited to a fixed position. By means of the point-surface contact between the surface of the conductive sheet and the first contact point, the efficiency of operating the electrical connection between the adjacent fans can be improved.

This example further provides a magic link fan, including a plurality of fans and the fan connecting structure. With this design, the plurality of fans can be electrically connected without complicated wire connection, which effectively improves the structural neatness in the fan mounting environment, thereby reducing the difficulty in organizing wires.

Further, in order to achieve a better connection effect, upper and lower ends of the adjacent fans are respectively provided with the fan connecting structure.

The disclosure has the following beneficial effects: In this technical solution, the adjacent fans are provided with the first connecting portions, the connector includes the substrate and the substrate is provided with the second connecting portions detachably combined with the first connecting portions, so the adjacent fans can be connected by means of the detachable combination between the second connecting portions on the substrate and the first connecting portions. Moreover, the first connecting portion is provided with the first contact points, the substrate is provided with the second contact points, the first contact point and the second contact point are in contact and electrically connected with each other, and the second contact points are electrically connected to the fan circuit board. Therefore, according to this design, the plurality of fans can be electrically connected in series without using complicated wires, but only by means of the connector connected between the first connecting portions of the adjacent fans. By means of this design, the plurality of fans can be electrically connected in series without physical wires, which solves the problem of messy and numerous wires in the existing design where the adjacent fans must be powered by multiple wires connected in series or by a concentrator, directly leading to the difficulty in organizing wires in the fan mounting space.

### BRIEF DESCRIPTION OF DRAWINGS

FIG. 1 is a schematic three-dimensional structural view of a fan from a first viewing angle according to the disclosure;

FIG. 2 is a schematic structural view of A in FIG. 1;

FIG. 3 is a schematic three-dimensional structural view of the fan from a second viewing angle according to the disclosure;

FIG. 4 is a schematic three-dimensional structural view of a plurality of fans connected in series by using the fan connecting structure of Example 6 according to the disclosure;

FIG. 5 is a schematic structural view of B in FIG. 4;

FIG. 6 is a schematic structural view of C in FIG. 4;

FIG. 7 is a schematic three-dimensional structural view of a plurality of fans connected in series by using the fan connecting structure of Example 5 according to the disclosure;

FIG. 8 is a schematic structural view of D in FIG. 7;

FIG. 9 is a schematic structural view of a connector from a first viewing angle according to the disclosure;

FIG. 10 is a schematic structural view of a connector from a second viewing angle according to the disclosure;

FIG. 11 is a schematic structural view of a connector from a third viewing angle according to the disclosure;

FIG. 12 is a schematic structural view of a connector from a fourth viewing angle according to the disclosure;

FIG. 13 is a schematic structural view of another connector from a first viewing angle according to the disclosure;

FIG. 14 is a schematic structural view of another connector from a second viewing angle according to the disclosure; and

FIG. 15 is a schematic structural view of another connector from a third viewing angle according to the disclosure.

In the figures: connector 1; fan 2; sliding slot 3; sliding portion 4; snap fit slot 5; snap fit fastener 6; guide slot 7; guide portion 8; snap fit edge 9; snap fit arm 10; snap fit head 11; spring ejector pin 12; conductive sheet 13.

### DETAILED DESCRIPTION OF THE EMBODIMENTS

### Example 1

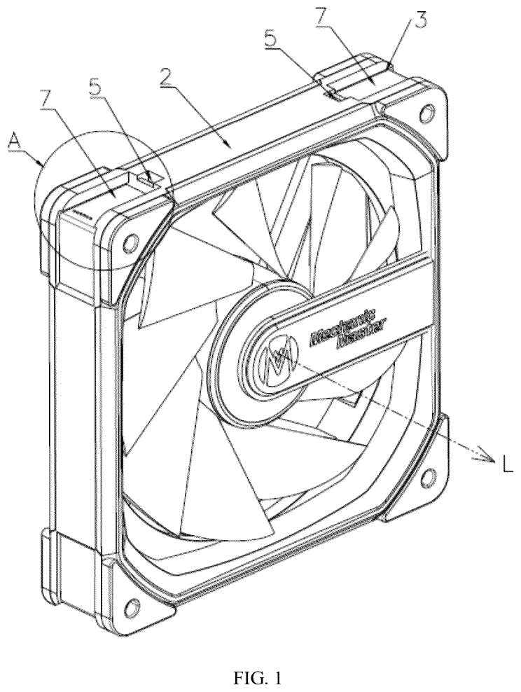

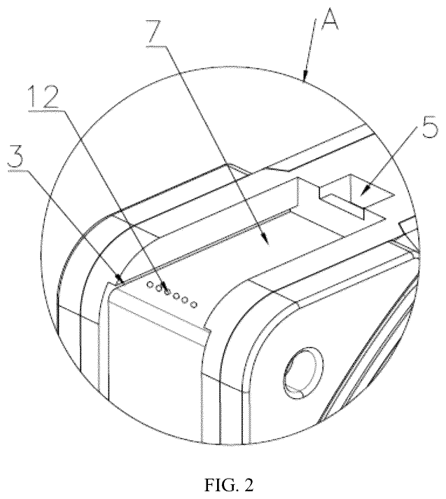

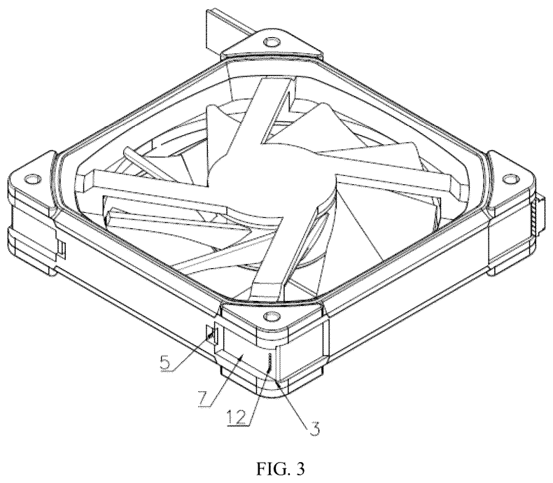

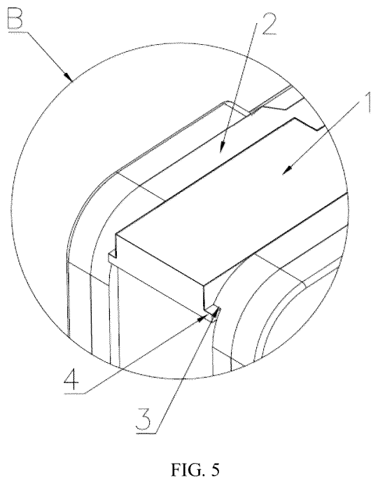

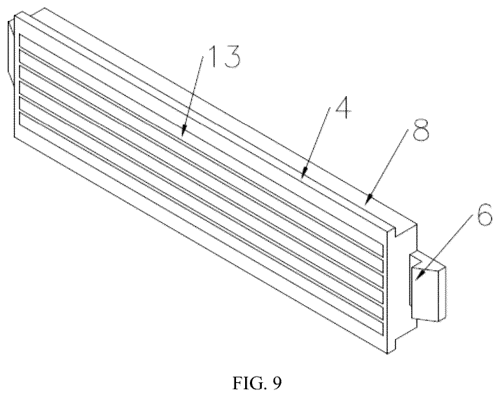

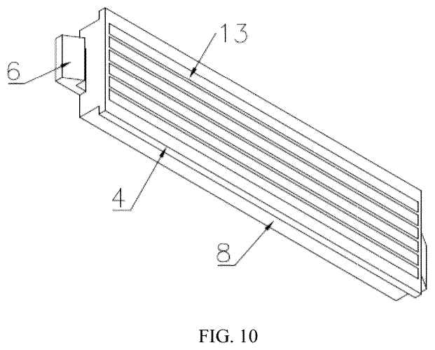

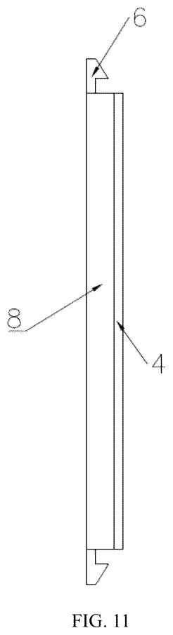

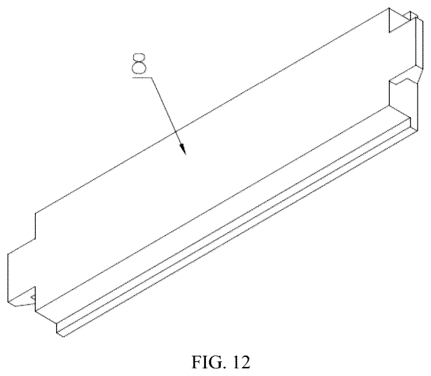

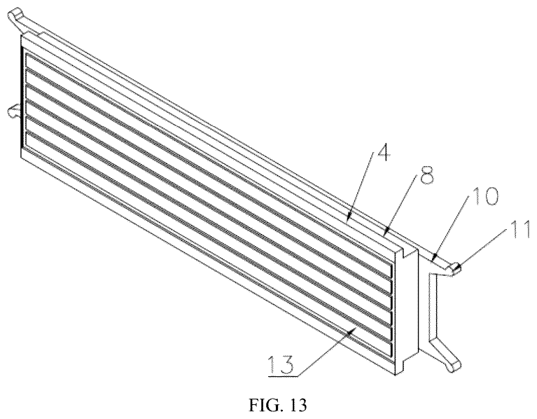

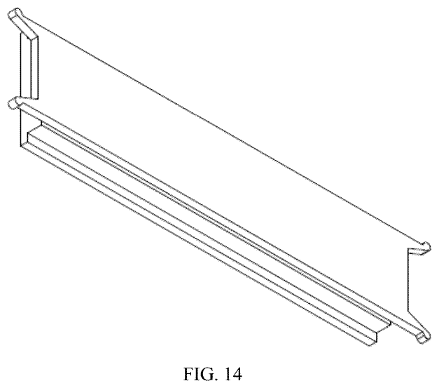

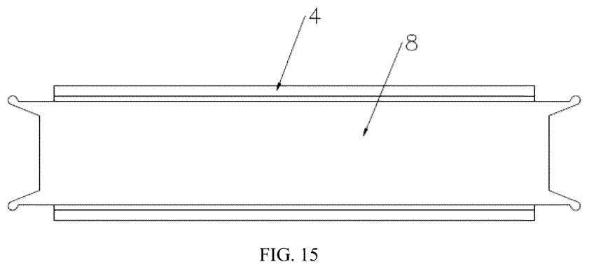

As shown in FIG. 1 to FIG. 15, this example provides a fan connecting structure, including a connector 1 and first connecting portions arranged on adjacent fans 2. The connector 1 includes a substrate. The substrate is provided with second connecting portions detachably combined with the first connecting portions. The first connecting portion is provided with first contact points. The substrate is provided with second contact points in contact with the first contact points. The second contact points are electrically connected to a fan 2 circuit board.

In this technical solution, the adjacent fans 2 are provided with the first connecting portions, the connector 1 includes the substrate and the substrate is provided with the second connecting portions detachably combined with the first connecting portions, so the adjacent fans 2 can be connected by means of the detachable combination between the second connecting portions on the substrate and the first connecting portions. Moreover, the first connecting portion is provided with the first contact points, the substrate is provided with the second contact points, the first contact point and the second contact point are in contact and electrically connected with each other, and the second contact points are electrically connected to the fan 2 circuit board. Therefore, according to this design, the plurality of fans 2 can be electrically connected in series without using complicated wires, but only by means of the connector 1 connected between the first connecting portions of the adjacent fans 2. By means of this design, the plurality of fans 2 can be electrically connected in series without physical wires, which solves the problem of messy and numerous wires in the existing design where the adjacent fans 2 must be powered by multiple wires connected in series or by a concentrator, directly leading to the difficulty in organizing wires in the fan mounting space.

It should be noted that the first connecting portions are detachably combined with the second connecting portions. The detachable combination here includes detachable fixed connection and detachable movable connection. When the detachable fixed connection is selected, after the adjacent fans 2 are connected by the connectors 1, the positions of the two fans 2 can be relatively fixed without external auxiliary limiting structures, thereby ensuring the contact effect between the first contact points and the second contact points. However, in another case, even when the detachable movable connection has been used between the first connecting portions and the second connecting portions, external auxiliary limiting structures may further be used to fix and limit adjacent fans 2 or a plurality of fans 2, which can also ensure the contact effect between the first contact point and the second contact point and the series electrical connection between the adjacent fans 2 and can also achieve the design objective of this technical solution. Therefore, the detachable combination between the first connecting portions and the second connecting portions is not limited to the detachable fixed connection therebetween.

### Example 2

This example is an optimization on the basis of Example 1.

In order to effectively limit the relative positions of the adjacent fans 2 such that the adjacent fans 2 can be stably kept electrically connected in series when there is no external auxiliary limiting structure for auxiliary limiting, the first connecting portion includes a first limiting structure and a second limiting structure that restrict the connector 1 from free disengagement, and the second connecting portion includes a third limiting structure fitted with the first limiting structure to realize detachable combination, and a fourth limiting structure fitted with the second limiting structure to realize detachable combination.

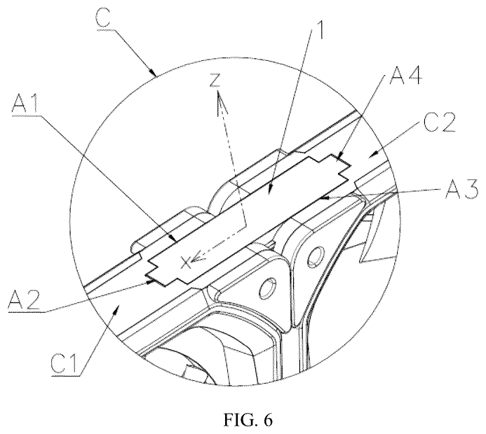

It should be noted that although the first limiting structure is fitted with the third limiting structure to realize detachable combination, the second limiting structure is fitted with the fourth limiting structure to realize detachable combination. That is, there are four detachable combination positions between the connector 1 and the two adjacent fans 2. Specifically, as shown in FIG. 6, the first limiting structure and the second limiting structure of the two fans 2 are respectively detachably combined with the third limiting structure and the fourth limiting structure of one connector 1 at positions A1 (the joint between the first limiting structure of the first fan C1 and the third limiting structure of the connector 1), A2 (the joint between the second limiting structure of the first fan C1 and the fourth limiting structure of the connector 1), A3 (the joint between the first limiting structure of the second fan C2 and the third limiting structure of the connector 1) and A4 (the joint between the second limiting structure of the second fan C2 and the fourth limiting structure of the connector 1). By means of the design of the four detachable combination positions, the connector 1 can be detachably fixed between the adjacent fans 2 from multiple directions, thereby achieving the effect of detachable fixed connection.

As shown in FIG. 6, the fit (A1, A3) between the first limiting structure and the third limiting structure can restrict the connector 1 from free disengagement in a Z direction, and the fit (A2, A4) between the second limiting structure and the fourth limiting structure can restrict the connector 1 from free disengagement in an X direction. The X direction and the Z direction are perpendicular to each other.

### Example 3

This example is an optimization on the basis of Example 2.

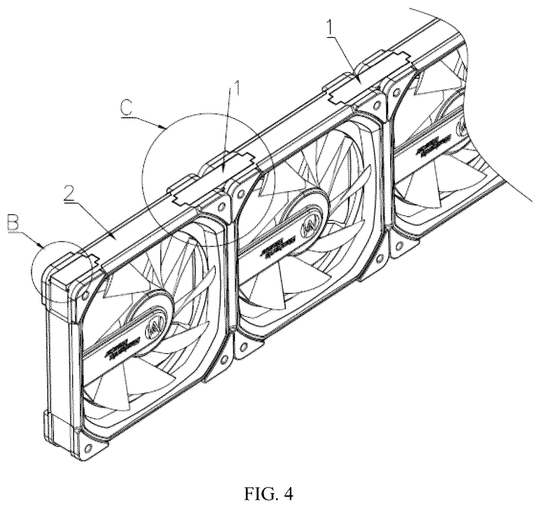

As shown in FIG. 4 to FIG. 6 and FIG. 9 to FIG. 12, in order to provide a detachable fixed connection manner between the fans 2 and the connector 1, the first limiting structure is in a sliding fit with the third limiting structure, and the second limiting structure is in a snap fit with the fourth limiting structure.

Specifically, the first limiting structure may be a sliding slot 3 arranged on the fan 2, and the third limiting structure may be a sliding portion 4 that is in a sliding fit with the sliding slot 3. The second limiting structure may be a snap fit slot 5 arranged on the fan 2, and the fourth limiting structure may be a snap fit fastener 6 arranged on the substrate.

Of course, in the case where the connection relationship between the sliding slot 3 and the sliding portion 4 and the connection relationship between the snap fit slot 5 and the snap fit fastener 6 are kept unchanged, they may be arranged either on the fan 2 or the connector 1.

For example, the sliding slot 3 may also be arranged on the connector 1, the sliding portion 4 may also be arranged on the fan 2, the snap fit fastener 6 may also be arranged on the fan 2, and the snap fit slot 5 may also be arranged on the connector 1.

It should be noted that in order to make the connector 1 flush with the frame of the fan 2 and guide the connection between the first limiting structure and the third limiting structure and the connection between the second limiting structure and the fourth limiting structure, a guide structure is arranged between the fan 2 and the connector 1. Specifically, the guide structure may be a guide slot 7 arranged on the fan 2, and the substrate is in a sliding fit with the guide slot 7. In this design, the surface on the substrate that is attached to the guide slot 7 is the contact surface, and the second contact points are located on the contact surface. In addition, in this design, there are two sliding slots 3 that are symmetrically arranged on two sides of the guide slot 7, and the bottom of the guide slot 7 is flush with the bottoms of the sliding slots 3. Openings of the two sliding slots 3 are arranged in opposite directions. During the mounting of the connector 1, the substrate is pushed inward for an appropriate distance toward the extending direction of the guide slot 7 until the second limiting structure is in a snap fit with the fourth limiting structure, for example, until the snap fit fastener 6 snaps into the snap fit slot 5.

Of course, in addition to the above design, the sliding fit structure between the substrate and the guide slot 7 may also be realized by arranging a guide slot 7 on the substrate and arranging a guide portion 8 in a sliding fit with the guide slot 7 on the fan 2. In this case, the surface in the guide slot 7 that is attached to the guide portion 8 is the contact surface, and the second contact points are located on the contact surface. This design can also achieve the same objective.

It should be noted that in order to achieve a better contact effect, the contact surface is preferably arranged on the bottom surface of the substrate or on the bottom surface of the guide slot 7 of the substrate.

### Example 4

This example is an optimization on the basis of Example 3.

In order to better realize the side-by-side arrangement between the adjacent fans 2, the first limiting structure and the third limiting structure slide in an X direction, and the X direction is perpendicular to a rotation axis L of the fan 2.

### Example 5

This example is an optimization on the basis of Example 4.

In order to realize arbitrary adjustment of the distance between the adjacent fans 2 according to needs, the snap fit position between the second limiting structure and the fourth limiting structure is arbitrarily adjustable.

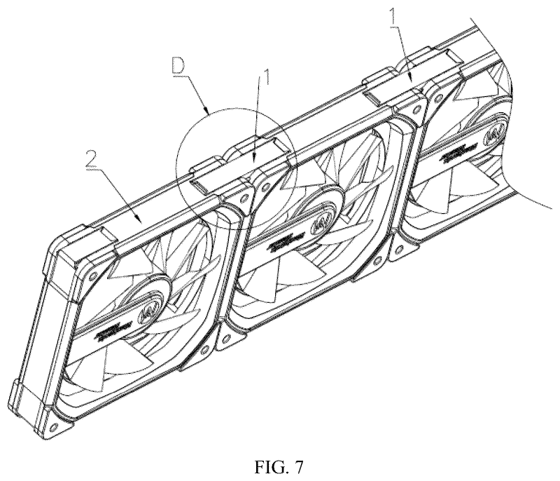

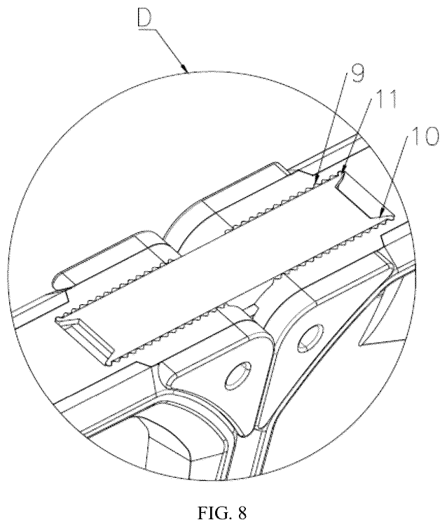

Specifically, as shown in FIG. 7, FIG. 8 and FIG. 14 to FIG. 15, when the fan 2 is provided with the guide slot 7, two side edges of the guide slot 7 are provided with snap fit edges 9. Correspondingly, the substrate is symmetrically provided with two snap fit arms 10. The two snap fit arms 10 are respectively provided with a snap fit head 11, and the snap fit head 11 is in a snap fit with the corresponding snap fit edge 9. While the substrate moves along the guide slot 7, the snap fit heads 11 can be fixed at different positions of the snap fit edges 9 along the length direction of the snap fit edges 9. In this design, the second limiting structure includes the snap fit edges, and the fourth limiting structure includes the snap fit arms 10 and the snap fit heads 11. Preferably, the snap fit edges 9 are wavy snap fit edges, and the snap fit heads 11 are arc-shaped snap fit heads. While operating the relative positions between the connector 1 and the fans 2, the arc-shaped snap fit head can be fixed at any arc-shaped recessed portion of the wavy snap fit edge. With this design, the fans can be powered and realize light control without being arranged next to each other, which greatly improves the flexibility of the fan mounting positions.

### Example 6

This example is an optimization on the basis of Example 4.

In order to design a connection manner in which the distance between the adjacent fans 2 is fixed, a snap fit position between the second limiting structure and the fourth limiting structure is a fixed snap fit position, and the fixed snap fit position is at a termination end of the sliding fit between the first limiting structure and the third limiting structure.

Specifically, according to the above design, the fixed snap fit position is at the termination end of the sliding fit between the first limiting structure and the third limiting structure. That is, only when the first limiting structure slides to the extreme position of the sliding fit relative to the third limiting structure, the second limiting structure is in a snap fit with the fourth limiting structure, and the distance between the adjacent fans 2 can be fixed.

It should be noted that in the actual application process, if the adjacent fans 2 need to be arranged side by side in close proximity to each other, then the length of the connector 1 is equal to the distance between the two fixed snap fit positions when the two adjacent fans 2 are side by side in close proximity to each other.

If the adjacent fans 2 need to arranged side by side at a fixed distance, then the length of the connector 1 is greater than the distance between the two fixed snap fit positions when the two adjacent fans 2 are side by side in close proximity to each other.

### Example 7

This example is an optimization on the basis of any of Examples 3 to 6.

The fan 2 is provided with contact heads, and the first contact point is located at a top of the contact head. The contact head is a spring ejector pin 12. With the spring ejector pin 12, the position of the first contact point can retract when the first contact point is pressed by the second contact point. In this way, when the connector 1 is connected with the fans 2, the first contact point and the second contact point can be kept in close contact with each other, thereby achieving the electrical connection effect and preventing poor contact from affecting the use effect of the product.

It should be noted that the first contact points are arranged in one-to-one correspondence to the second contact points, and the number of the first contact points and the number of the second contact point may be adaptively increased or decreased according to the needs for functional expansion of the fans 2.

For example, in an RGB fan, a motor electrical connection interface and an RGB light interface are needed. Therefore, when this design is applied to an RGB fan, the numbers of the first contact points and the second contact points are respectively six. The numbers of the first contact points and the second contact points for controlling the motor and the RGB light are respectively three.

It should be noted that the spring ejector pins 12 may be arranged at any positions in the guide slot 7. However, in order to make the distance between the adjacent fans 2 adjustable by the connector 1, preferably, the spring ejector pins 12 are arranged at the outer end of the guide slot 7. In this way, when the distance between the adjacent fans 2 needs to be adjusted by adjusting the specific positions of the fixed snap fit positions, even if the distance between the two adjacent fans 2 is kept at the farthest distance, the second contact points on the connector 1 can effectively contact the first contact points on the fans 2.

### Example 8

This example is an optimization on the basis of Example 1 or 7.

In order to facilitate the effective contact between the second contact point and the first contact point, the connector 1 is provided with a contact surface, the contact surface is provided with conductive sheets 13, and the second contact points are located on the conductive sheets 13.

With the conductive sheets 13, the position of the second contact point is not limited to a fixed position. By means of the point-surface contact between the surface of the conductive sheet 13 and the first contact point, the efficiency of operating the electrical connection between the adjacent fans 2 can be improved. Specifically, the conductive sheets 13 are copper sheets.

### Example 9

As shown in FIG. 1 to FIG. 15, the disclosure further provides a magic link fan 2, including a plurality of fans 2 and the fan connecting structure according to any of Examples 1 to 8. With this design, the plurality of fans 2 can be electrically connected without complicated wire connection, which effectively improves the structural neatness in the fan mounting environment, thereby reducing the difficulty in organizing wires.

### Example 10

This example is an optimization on the basis of Example 9.

In order to achieve a better connection effect, upper and lower ends of the adjacent fans 2 are respectively provided with the fan connecting structure.

According to this technical solution, when it is required to connect a plurality of fans 2, the plurality of fans 2 can be electrically connected in series without using wires, but simply by means of fastening every two adjacent fans 2 with the connector 1, which is simple in structural design. Compared with the traditional design where the fans 2 need to be sequentially inserted into a plurality of interfaces, this technical solution can realize the series electrical connection between the plurality of fans 2 more conveniently. The plurality of fans are directly connected, and the motor and the RGB light are connected at the same time, which greatly reduces the excess wires and connectors. After the plurality of fans are connected side by side, a wire is led out from one fan connector and finally connected to the motherboard power supply and RGB interface.

It should be finally noted that the above is merely preferred examples of the disclosure and it is not intended to limit the protection scope of the disclosure. Any modification, equivalent replacement, or improvement made within the spirit and principle of the disclosure shall fall into the protection scope of the disclosure.

What is claimed is:

1. A fan connecting structure, comprising a connector and first connecting portions arranged on adjacent fans, wherein the connector comprises a substrate, the substrate is provided with second connecting portions detachably combined with the first connecting portions, the first connecting portion is provided with first contact points, the substrate is provided with second contact points in contact with the first contact points, and the second contact points are electrically connected to a fan circuit board.

2. The fan connecting structure according to claim 1, wherein the first connecting portion comprises a first limiting structure and a second limiting structure that restrict the connector from free disengagement, and the second connecting portion comprises a third limiting structure fitted with the first limiting structure to realize detachable combination, and a fourth limiting structure fitted with the second limiting structure to realize detachable combination.

3. The fan connecting structure according to claim 2, wherein the first limiting structure is in a sliding fit with the third limiting structure, and the second limiting structure is in a snap fit with the fourth limiting structure.

4. The fan connecting structure according to claim 3, wherein the first limiting structure and the third limiting structure slide in an X direction, and the X direction is perpendicular to a rotation axis L of the fan.

5. The fan connecting structure according to claim 4, wherein a snap fit position between the second limiting structure and the fourth limiting structure is arbitrarily adjustable.

6. The fan connecting structure according to claim 4, wherein a snap fit position between the second limiting structure and the fourth limiting structure is a fixed snap fit position.

7. The fan connecting structure according to claim 1, wherein the fan is provided with contact heads, and the first contact point is located at a top of the contact head.

8. The fan connecting structure according to claim 1, wherein the connector is provided with a contact surface, the contact surface being provided with conductive sheets, and the second contact points being located on the conductive sheets.

9. A magic link fan, comprising a plurality of fans and the fan connecting structure according to claim 1.

10. The magic link fan according to claim 9, wherein upper and lower ends of the adjacent fans are respectively provided with the fan connecting structure.
